(19) United States
(12) Patent Application Publication
(10) Pub. No.: US 2017/0291289 A1
(43) Pub. Date: Oct. 12, 2017

(54) CONNECTING ROD FOR AN IMPACT MEMBER OF AN IMPACT TOOL

(71) Applicant: CENTRIFUGE INDUSTRIAL CO., LTD., Taichung City (TW)

(72) Inventor: BING-SHENG CHEN, Taichung City (TW)

(21) Appl. No.: 15/634,419

(22) Filed: Jun. 27, 2017

Related U.S. Application Data
(63) Continuation-in-part of application No. 14/282,508, filed on May 20, 2014.

(51) Int. Cl. B25D 3/00; B25D 17/02

(52) U.S. Cl. CPC B25D 3/00; B25D 17/02; B25D 2250/111; B25D 2250/321; B25D 2250/345

(57) ABSTRACT

A connecting rod for an impact member of an impact tool is provided. The impact member comprises an impacting portion, a connecting portion axially opposite to the impacting portion and a radial flange between the impacting portion and the connecting portion. The radial flange includes a first abutting surface facing the connecting portion. The impact member is insertable into the impact tool and detachably blocked by the impact tool. The connecting rod includes a rod body. The rod body includes receiving end surface and impacting end surface, and a holding portion between the receiving end surface and the impacting end surface. The receiving end surface is recessed to form an assembling slot. The assembling slot includes a second abutting surface disposed circumferentially. When the connecting portion is inserted in the assembling slot, the first abutting surface abuts against the second abutting surface.

### BACKGROUND OF THE INVENTION

### Field of the Invention

The present invention is a CIP of application Ser. No. 14/282508, filed May 20, 2014, the entire contents of which are hereby incorporated by reference.

### Description of the Prior Art

Impact tools are quite common and applied in various industries, such as mobile industry, building construction or road maintenance. The impact tools are convenient for equipping with different impact members to work and able to convert a compressive air source into an impacting force effectively. And the impact tools also provide the big impacting force for large constructions and improve the working efficiency.

However, in some practical construction works, it is necessary to use a hand tool and operate by hand. Especially in some works that the impact tools are unachievable, such that a small impacting force is needed to apply on a work area while the impact tools are unable to provide or the impact tools are unable to be applied because of work space limitation. And when the impact tools are unable to be applied, operators usually take a hand tool and use a hammer to strike the hand tool to work. But there are a variety of working types, so there are also a variety of hand tools corresponding to the different working types. It is inconvenient for the operators to carry so many hand tools, and it is not easy to manage so many hand tools.

U.S. Pat. No. 7,478,464 discloses that the assembling slot is a screw hole without a horn section having a smooth abutting surface. The impact member should be rotated for turns to screw with the connecting rod and is unable to be withdrawn quickly. The assembling slot cannot receive an impact member with a horn-shaped flange which is insertable into the impact tool and detachably blocked by the impact tool.

US20150360295 discloses that the assembling slot is a screw hole, so that the screw-in tool cannot bear great impact force and cannot be changed quickly.

U.S. Pat. No. 7,669,860 discloses that the annular spring member and the bit detent ball are not integrally formed of one piece, so that it is complicated for fabrication and assembling and is costly.

The present invention has arisen to mitigate and/or obviate the afore-described disadvantages.

### SUMMARY OF THE INVENTION

The primary object of the present invention is to provide a connecting rod for an impact member of an impact tool. The connecting rod is convenient and fast for assembling/disassembling with the different impact members and helps the impact tool to finish some work that the impact tool is unachievable. The connecting rod increases the working efficiency and has a simple structure so that it is easy for producing and saves cost.

To achieve the above object, a connecting rod for an impact member of an impact tool is provided. The impact member comprises an impacting portion, a connecting portion axially opposite to the impacting portion and a radial flange between the impacting portion and the connecting portion. The radial flange includes a first abutting surface facing the connecting portion. The impact member is insertable into the impact tool and detachably blocked by the impact tool. The connecting rod includes a rod body. The rod body includes receiving end surface and impacting end surface, and a holding portion between the receiving end surface and the impacting end surface. The receiving end surface is recessed to form an assembling slot. The assembling slot includes a second abutting surface disposed circumferentially. When the connecting portion is inserted in the assembling slot, the first abutting surface abuts against the second abutting surface.

### BRIEF DESCRIPTION OF THE DRAWINGS

FIG. 1 is a breakdown drawing of a connecting rod in accordance with a first embodiment of the present invention;

FIG. 2 is a perspective drawing of the connecting rod in accordance with the first embodiment of the present invention;

FIG. 3 is a breakdown drawing of the connecting rod in accordance with a second embodiment of the present invention;

FIG. 4 is a partial cross-sectional drawing of the connecting rod in accordance with the second embodiment of the present invention;

FIG. 5 is a drawing showing an impact member blocked within an impact tool; and

FIG. 6 is a partial cross-sectional drawing of an impacting end portion of the connecting rod in accordance with another embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

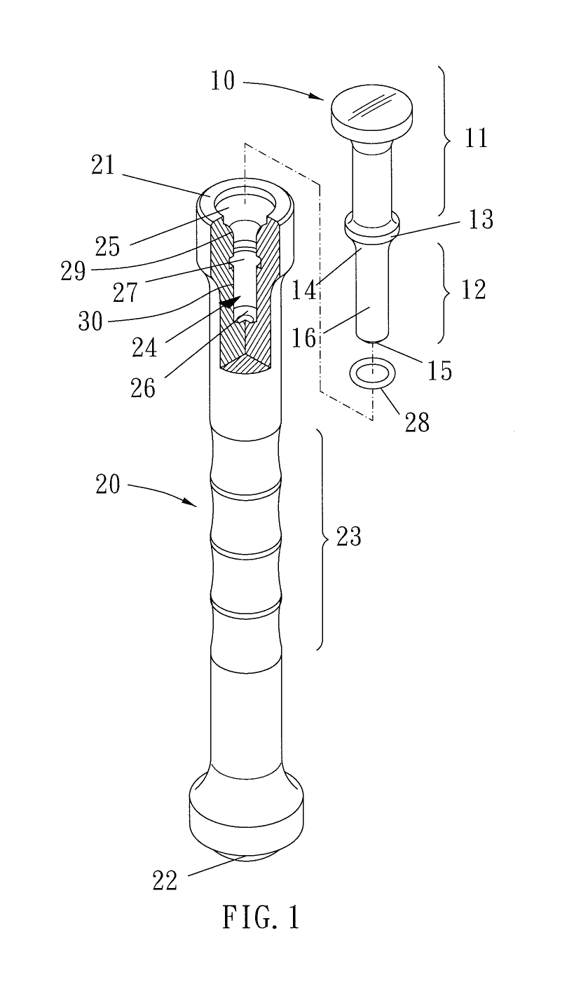

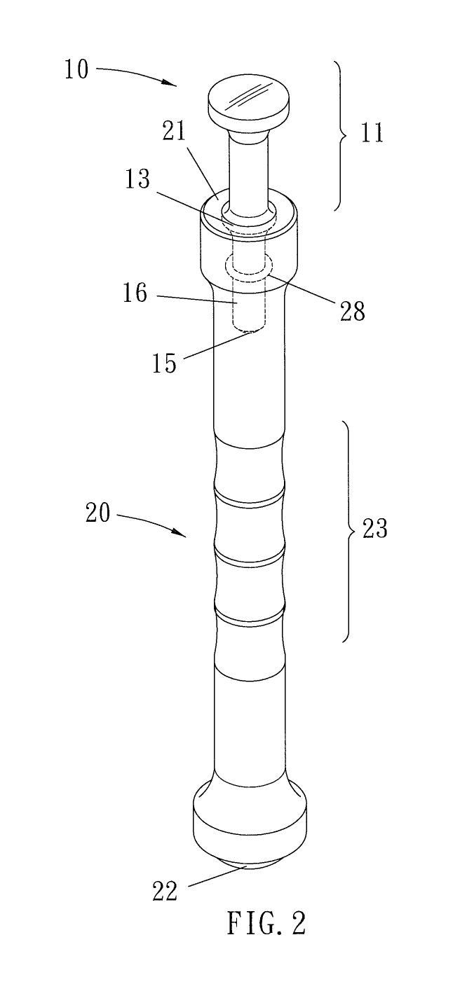

Referring to FIGS. 1-2, it shows a connecting rod in accordance with a first embodiment of the present invention. The impact member 10 includes an impacting portion 11, a connecting portion 12 axially opposite to the impacting portion 11 and a radial flange 13 between the impacting portion 11 and the connecting portion 12, and the radial flange 13 includes a first abutting surface 14 facing the connecting portion 12. Practically, the impact member 10 has a variety of different shapes. The impacting portion 11 is such as flat-shaped, sharp-shaped or camber-shaped. The connecting portion 12 is such as a circumferential surface of a cylinder or a polygonal pillar and for connecting with the impact tool or the connecting rod. In the present embodiment, the connecting portion 12 is the circumferential surface of a cylinder. The impacting portion 11 and the connecting portion 12 have a same axial direction.

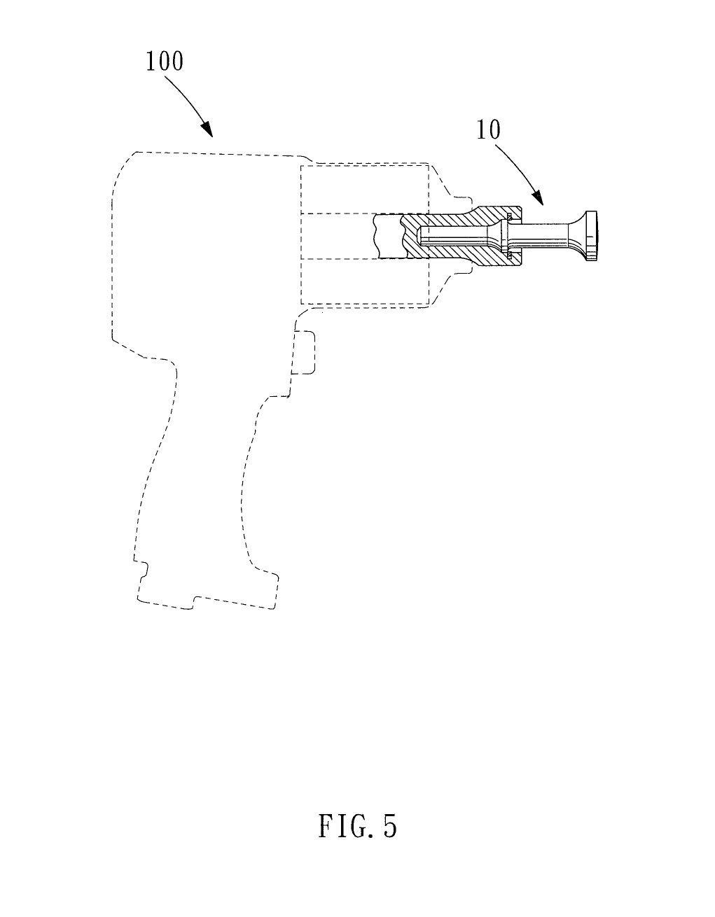

The impact member 10 is insertable into the impact tool 100 and detachably blocked by the impact tool (as shown in FIG. 5). For example, the impact tool is stuckable with the radial flange 13 through a pushing device with a spring. When the impact member 10 is assembled or disassembled, the pushing device can be pushed backwardly so that the impact member 10 is able to be inserted in or taken out. The first abutting surface 14 is for abutting against the impact tool or the connecting rod. Practically, the impact tool is able to equip with the different impact members 10, and the impact member 10 is conveniently assembled or disassembled through a device which can block the radial flange 13 of the impact member 10.

The connecting rod includes a rod body 20, and the rod body 20 includes an axially opposing receiving end surface 21 and an impacting end surface 22, a receiving end portion 33 having the receiving end surface 21, and a holding portion 23 between the receiving end surface 21 and the impacting end surface 22. The receiving end surface 21 is recessed to form an assembling slot 24. Practically, the assembling slot 24 is for assembling with the impact member 10. The assembling slot 24 includes a second abutting surface 25 disposed circumferentially. When the connecting portion 12 is inserted in the assembling slot 24, the first abutting surface 14 abuts against the second abutting surface 25. Moreover, the first abutting surface 14 corresponds to the second abutting surface 25 in shape. The first abutting surface 14 and the second abutting surface 25 are such as annular surfaces or conical surfaces (they can be cambers, flat surfaces or other types). An impacting force is able to be effectively transmitted between the first abutting surface 14 and the second abutting surface 25, and it avoids that the impact member 10 is damaged.

The connecting portion 12 is formed with an end surface 15 in an axial direction, and the assembling slot is formed with a bottom surface 26 in an axial direction. When the connecting portion 12 is inserted into the assembling slot 24, the end surface 15 abuts against the bottom surface 26. The end surface 15 and the bottom surface 26 are such as conical surfaces. Preferably, because the first and second abutting surfaces 14, 25 abut against each other and the end surface 15 abuts against the bottom surface 26, the impacting force applied on the connecting rod is effectively transmitted to the impact member 10 and it increases working efficiency. It is noted that, the impacting force is transmitted through two paths. The impacting force will not decay and the impacting force will not concentrate on a single point. As a result, the connecting portion 12 of the impact member 10 is not damaged or deformed.

Preferably, the connecting portion 12 further includes a first extending circumferential surface 16, and the assembling slot 24 further includes a second extending circumferential surface 27 extending from the second abutting surface 25 inwardly. When the connecting portion 12 is inserted in the assembling slot 24, the first extending circumferential surface 16 abuts against the second extending circumferential surface 27. Practically, the first extending circumferential surface 16 of the impact member 10 is laterally abutted against the second extending circumferential surface 27 of the connecting rod. Preferably, the connecting rod and the impact member 10 can be matched fittingly so that they are unshakable between each other. It helps the transmission of the impacting force between the connecting rod and the impact member 10, increases work efficiency and avoids that the impact member 10 is deformed and damaged.

Specifically, the receiving end portion 33 and the holding portion 23 are integrally formed of one piece, and the receiving end portion 33 includes a horn shaped flange 331 and is greater than the holding portion 23 in diametrical dimension. The assembling slot 24 further includes a cylindrical opening 211 which is open at the receiving end surface 21, a horn section 29 extending from the cylindrical opening 211 and a cylindrical section 30 extending from the horn section 29 and away from the receiving end surface 21, the cylindrical section 30 includes the second extending circumferential surface 27, the horn shaped flange 331 has the horn section 29 thereinside, the horn section 29 is smoothly curvedly enlarged outwardly toward the receiving end surface 21 from the cylindrical section 30 to the cylindrical opening 211, the horn section 29 has the second abutting surface 25, and the second abutting surface 25 is smooth. The cylindrical section 30 includes the second extending circumferential surface 27.

The rod body 20 further includes a stuck member 28, and the stuck member 28 is disposed in the assembling slot 24. When the connecting portion 12 is inserted in the assembling slot 24, the first extending circumferential surface 16 abuts against the stuck member 28. The stuck member 28 is an annular elastic member. When the connecting portion 12 is inserted in the assembling slot 24, a friction is induced between the stuck member 28 and the first extending circumferential surface 16 so that it prevents that the impact member 10 from dropping out. Furthermore, in other embodiments, the assembling slot 24 can be covered with an elastic layer on the wall, and the friction can be also induced to prevent the impact member 10 from dropping out.

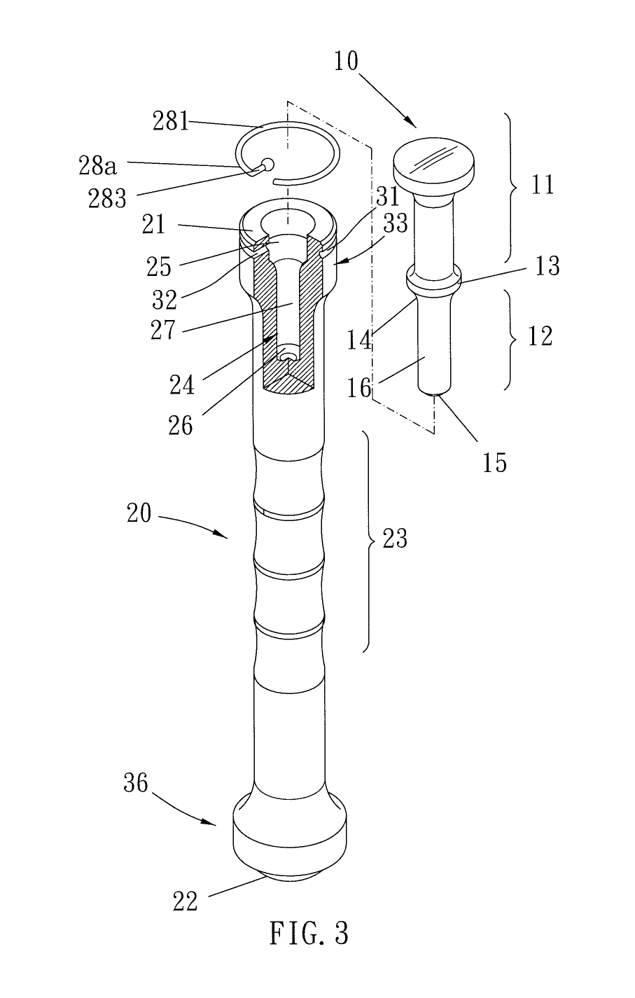

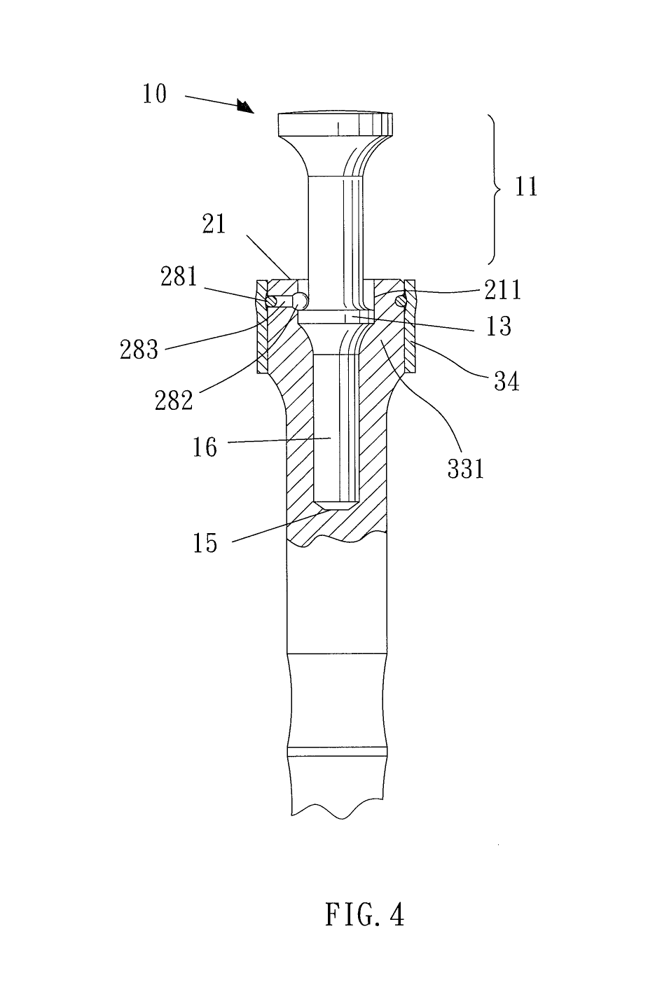

Referring to FIGS. 3-4, in another embodiment, the stuck member 28a is disposed on the rod body 20 and includes a C-shaped elastic buckling member 281, a ball-shaped member 282 and a straight member 283 which is radially connected integrally with and between the C-shaped elastic buckling member and the ball-shaped member 282. When the connecting portion is inserted in the assembling slot, the ball-shaped member is engaged on a side surface of the radial flange 13 opposite to the first abutting surface. When the impact member 10 is assembled or disassembled, the ball-shaped member is pushed backwardly so that the impact member 10 is able to be inserted in or taken out.

Specifically, the receiving end portion 33 further includes a groove 31 formed circumferentially on an outer surface thereof and around the second abutting surface 25, and the receiving end portion 33 further includes a through hole 32 radially communicated with the assembling slot 24 and disposed between the receiving end surface 21 and the second abutting surface 25. The stuck member 28a is integrally formed of one piece, the C-shaped elastic buckling member 281 is received in the groove 31, the straight member 283 is disposed through the through hole 32, and the ball-shaped member 282 is exposed within the assembling slot 24.

When the operator uses the impact tool to impact a work area, and if it is necessary to use the hand tool and operate by hand on some area such that a small impacting force is needed or work space is limited, the operator disassembles the impact member 10 from the impact tool and assembles the impact member 10 on the connecting rod rapidly. Then the operator holds the holding portion 23 of the connecting rod by hand and uses a manual tool (such as a hammer) to impact the impacting end surface 22. The impacting force is transmitted to the impact member 10 through the connecting rod and applied on the work area. The connecting rod is convenient and easy to use and increases the working efficiency. The connecting rod also has a simple structure and is easy to produce.

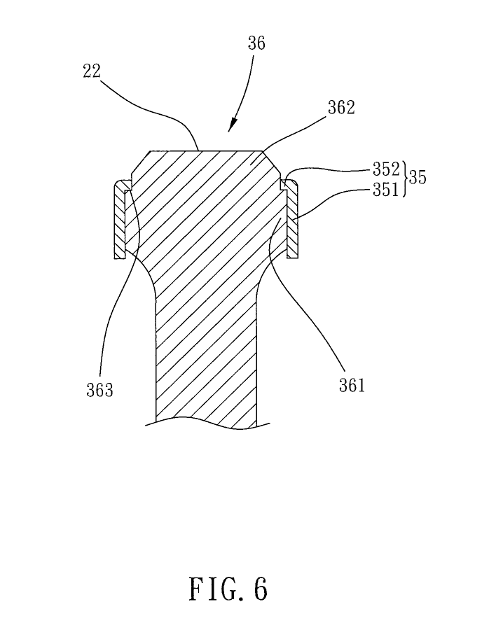

As shown in FIGS. 3, 4 and 6, the connecting rod preferably further includes a flexible ring member 34 and a flexible sleeve member 35. The flexible ring member 34 is circumferentially disposed around and engaged on the receiving end portion 33 and the C-shaped elastic buckling member 281. The rod body 20 further includes an impacting end portion 36 having the impacting end surface 22, the impacting end portion 36 further includes an annular flange 361 and a distal end bump 362 projecting from the annular flange 361 and having the impacting end surface 22, the annular flange 361 and the distal end bump 362 form a shoulder 363, the flexible sleeve member 35 includes a tubular body 351 and an annular inner flange 352 radially inwardly extending from the tubular body 351, the tubular body 351 is circumferentially disposed around and engaged on the annular flange 361, the annular inner flange 352 is annularly abutted against the shoulder 363 axially, and the distal end bump 362 is protrusive beyond the annular inner flange 352. The flexible ring member 34 and the flexible sleeve member 35 can prevent the connecting rod 20 from being damaged and deformed.

As a conclusion, the connecting rod is convenient and fast for assembling/disassembling with the different impact members. The connecting rod increases the working efficiency and has a simple structure so that it is easy to produce and saves cost.

While we have shown and described various embodiments in accordance with the present invention, it should be clear to those skilled in the art that further embodiments may be made without departing from the scope of the present invention.

What is claimed is:

1. A connecting rod for an impact member of an impact tool, the impact member comprising an impacting portion, a connecting portion axially opposite to the impacting portion and a radial flange between the impacting portion and the connecting portion, the radial flange including a first abutting surface facing the connecting portion, the impact member being insertable into the impact tool and detachably blocked by the impact tool, the connecting rod including :
a rod body, including an axially opposing receiving end surface and an impacting end surface, a receiving end portion having the receiving end surface, and a holding portion between the receiving end surface and the impacting end surface, the receiving end surface recessed to form an assembling slot, the assembling slot including a second abutting surface disposed circumferentially;
wherein when the connecting portion is inserted in the assembling slot, the first abutting surface abuts against the second abutting surface;
wherein the receiving end portion and the holding portion are integrally formed of one piece, and the receiving end portion includes a horn shaped flange and is greater than the holding portion in diametrical dimension;
wherein the assembling slot further includes a cylindrical opening which is open at the receiving end surface, a horn section extending from the cylindrical opening and a cylindrical section extending from the horn section and away from the receiving end surface, the horn shaped flange has the horn section thereinside, the horn section is smoothly curvedly enlarged outwardly toward the receiving end surface from the cylindrical section to the cylindrical opening, the horn section has the second abutting surface, and the second abutting surface is smooth;
wherein receiving end portion further includes a groove formed circumferentially on an outer surface thereof and around the second abutting surface, the receiving end portion further includes a through hole radially communicated with the assembling slot and disposed between the receiving end surface and the second abutting surface, the rod body further includes a stuck member, the stuck member is integrally formed of one piece, the stuck member includes a C-shaped elastic buckling member received in the groove, a ball-shaped member and a straight member which is radially connected integrally with and between the C-shaped elastic buckling member and the ball-shaped member, the straight member is disposed through the through hole, the ball-shaped member is exposed within the assembling slot, and when the connecting portion is inserted in the assembling slot, the ball-shaped member is engaged on a side surface of the radial flange opposite to the first abutting surface.

2. The connecting rod as claimed in claim 1, wherein the first abutting surface corresponds to the second abutting surface in shape.

3. The connecting rod as claimed in claim 1, wherein the first abutting surface and the second abutting surface are annular surfaces.

4. The connecting rod as claimed in claim 1, wherein the first abutting surface and the second abutting surface are conical surfaces.

5. The connecting rod as claimed in claim 1, wherein the connecting portion is formed with an end surface in an axial direction, the assembling slot is formed with a bottom surface in an axial direction, when the connecting portion is inserted in the assembling slot, the end surface abuts against the bottom surface.

6. The connecting rod as claimed in claim 5, wherein the end surface and the bottom surface are conical surfaces.

7. The connecting rod as claimed in claim 1, wherein the connecting portion further includes a first extending circumferential surface, the cylindrical section includes a second extending circumferential surface extending from the second abutting surface inwardly, when the connecting portion is inserted in the assembling slot, the first extending circumferential surface abuts against the second extending circumferential surface.

8. The connecting rod as claimed in claim 5, wherein the connecting portion further includes a first extending circumferential surface, the cylindrical section includes a second extending circumferential surface extending from the second abutting surface inwardly, when the connecting portion is inserted in the assembling slot, the first extending circumferential surface abuts against the second extending circumferential surface.

9. The connecting rod as claimed in claim 1, further including a flexible ring member, and the flexible ring member is circumferentially disposed around and engaged on the receiving end portion and the C-shaped elastic buckling member.

10. The connecting rod as claimed in claim 1, further including a flexible sleeve member, wherein the rod body further includes an impacting end portion having the impacting end surface, the impacting end portion further includes an annular flange and a distal end bump projecting from the annular flange and having the impacting end surface, the annular flange and the distal end bump form a shoulder, the flexible sleeve member includes a tubular body and an annular inner flange radially inwardly extending from the tubular body, the tubular body is circumferentially disposed around and engaged on the annular flange, the annular inner flange is annularly abutted against the shoulder axially, and the distal end bump is protrusive beyond the annular inner flange.
